(19) United States
(12) Patent Application Publication
(10) Pub. No.: US 2012/0024213 A1
(43) Pub. Date: Feb. 2, 2012

(54) REMOTE CONTROLLER FOR A BOAT

(76) Inventor: Giuseppe Brianza, Cusano Milanino (IT)

(21) Appl. No.: 13/148,443

(22) PCT Filed: Feb. 11, 2010
(86) PCT No.: PCT/EP2010/000846

§ 371 Date: Oct. 4, 2011

(30) Foreign Application Priority Data
Feb. 11, 2009 (IT) MI2009A0001

(51) Int. Cl. B63H 21/22; G08C 17/02; B63H 21/21

(52) U.S. Cl. 114/144 RE

(57) ABSTRACT

A remote controller for a boat, such as a yacht having at least one electronic, electromechanical or mechanical control and at least one manual control connected to the electronic, electromechanical or mechanical control for its actuation, the controller includes a handheld mobile transmitter and a receiver located on the boat, the transmitter being capable of generating signals that can be detected by the receiver without a wired connection between the transmitter and the receiver. The receiver has at least one output connected functionally to the at least one electronic, electromechanical or mechanical control of the boat in parallel with an output of the manual control. The transmitter does not replace the existing controls of the boat. The transmitter is capable of generating signals on at least two different frequency bands, which can be detected by the receiver without a wired connection between the transmitter and the receiver. The receiver is provided with at least two different receiver stages: one receiver stage for each one of the frequency bands emitted by the transmitter. Each receiver stage is autonomous and receives the same information, allowing to maintain control even in the presence of interference or malfunctions on one of the two transmitted bands.

The present invention relates to a remote control system for a boat, particularly a yacht.

As is known, maneuvering a boat in tight spaces, for example in port, has problems and difficulties.

In particular, during mooring, the person at the controls generally is not in the best location for monitoring the movement and position of the boat relative to the dock. It is therefore usually necessary to seek assistance from one or more persons elsewhere on the boat or on the dock.

However, difficulties in communications often occur between the operator who is at the controls of the boat and the people located elsewhere on the boat or dock, and an incomplete or incorrect communication can lead to damage to the boat itself or to the adjacent boats and can injure the people assigned to the maneuver or people in the vicinity.

The need has therefore been observed for a remote control system that can overcome the drawbacks cited above.

By controlling remotely the boat and all the devices that are present on board, in theory one operator, without assistance, could control the boat and its devices, monitoring the position of the boat with respect to the dock and to the other nearby boats from a position that offers better visibility and safety.

Various attempts at remote control have been proposed, and all can be perfected both from the point of view of functionality and especially from the point of view of safety and reliability.

U.S. Pat. No. 6,264,513 discloses a wireless marine control system for extending the control functions of the electrically actuated control systems of a boat, substantially for remotely controlling the sound system of the boat. The apparatus includes a plurality of transmitters and receivers. Each transmitter generates a signal on two channels and the receiver synthesizes a third control signal form the combination of the two signals.

EP-1544097, by this same applicant, discloses an effective wireless remote control system, which enables a precise control of a yacht or other vessel from virtually any point on the yacht. The system includes a hand-held transmitter having various switches for controlling the engines, thrusters, anchor winch, etc., and a receiver connected to the existing electronic controls of the yacht.

The aim of the present invention is to provide an improved remote controller both from the point of view of functionality and, especially, of safety and reliability.

An object of the invention is to provide a device that allows to control the engines, thrusters, the anchor winch and/or other devices of the boat from a remote position.

Another object of the invention is to provide a device that allows to control a boat precisely with a wireless means and by virtue of a handheld device.

Another object is to provide a control device that allows to reduce the number of crewmembers needed to perform the various tasks that entail maneuvering a boat and also to simplify the operations that require the intervention of a single person.

Another object of the invention is to provide a device that can be installed easily on existing boats without substantial modifications to the boats.

Another object of the invention is to provide a device that works in parallel with the conventional controls of the boat and does not replace the controls.

Another object of the invention is to provide a device that allows to alert the user when the radio communication between the handheld transmitter and the receiver has been interrupted.

This aim and these and other objects that will become better apparent hereinafter are achieved by a remote controller for a boat comprising at least one electronic, electromechanical or mechanical control and at least one manual control connected to said electronic, electromechanical or mechanical control for its actuation, said controller comprising a handheld mobile transmitter and a receiver located on the boat, said transmitter being capable of generating signals that can be detected by the receiver without a wired connection between the transmitter and the receiver; said receiver having at least one output connected functionally to said at least one electronic, electromechanical or mechanical control of the boat in parallel with an output of said manual control; said transmitter not replacing the existing controls of the boat; said controller being characterized in that said transmitter is capable of generating signals on at least two different frequency bands which can be detected by the receiver without a wired connection between the transmitter and the receiver.

Signal transmission in the device according to the present invention is performed on two different frequency bands in order to considerably improve the reliability and safety of the communication between the transmitter and the receiver. In other devices with single-band signal transmission, an interference can in fact prevent correct reception of the commands, preventing correct actuation of the controls of the boat.

The receiver of the controller, according to the present invention, is provided with at least two different receiving stages; a receiving stage for each one of the frequency bands emitted by the transmitter.

Each receiving stage is autonomous and receives the same information, allowing to maintain control even in the presence of interference or malfunctions on one of the two transmitted bands.

The receiver is preferably mounted on a structure on the boat and is designed to be stationary.

The receiver has outputs, which are activated when the corresponding signals are received from the transmitter.

The outputs from the receiver are connected to the existing controls of the boat. In particular, the outputs of the receiver are connected in parallel to the conventional controls, so that the device according to the present invention can act in addition to the conventional control system provided on board but does not replace the existing system.

The receiver includes or is connected to an acoustic transducer or other equivalent device, in order to sound an alert when the radio communication between the transmitter and the receiver is interrupted.

This alarm alerts the user that the boat must be controlled conventionally because the transmitter is not connected to the receiver.

The device according to the invention allows a user to control in practice any movement of the boat while staying in any position on the boat.

Therefore, the user can control carefully a mooring operation, for example from the bow or stern of the boat, having precise control over the engines, the thrusters and the other controlled devices.

The result is that in general operations that require two or more people with conventional systems can be performed by a single operator without assistance and with higher safety and precision by using the device according to the present invention.

The present invention also has the important advantage of being easily installable on existing boats provided with electronic, electromechanical and mechanical controls and does not require the boats to be modified except to connect the receiver to the controls that already exist on the boat.

Further characteristics and advantages will become better apparent from the description of preferred but not exclusive embodiments of the invention, illustrated by way of non-limiting example in the accompanying drawings, wherein:

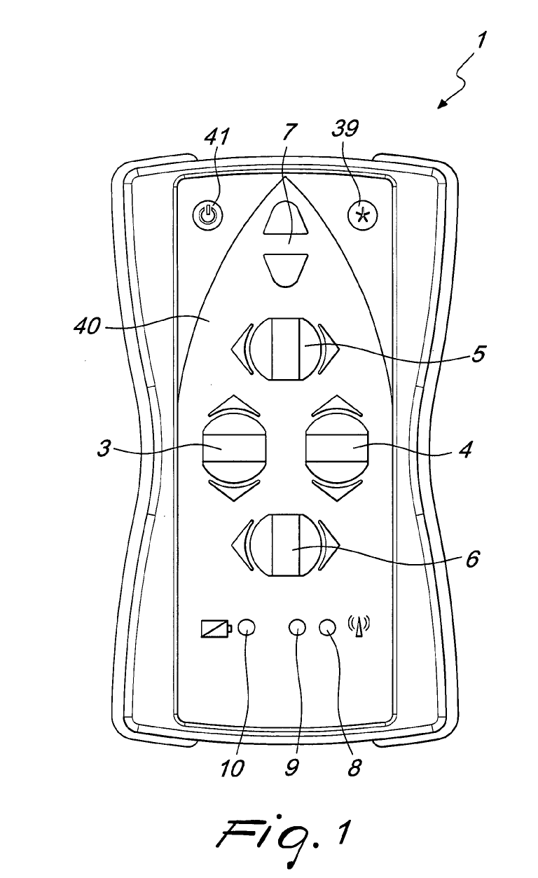

FIG. 1 is a plan view of the transmitter of the control device according to the invention;

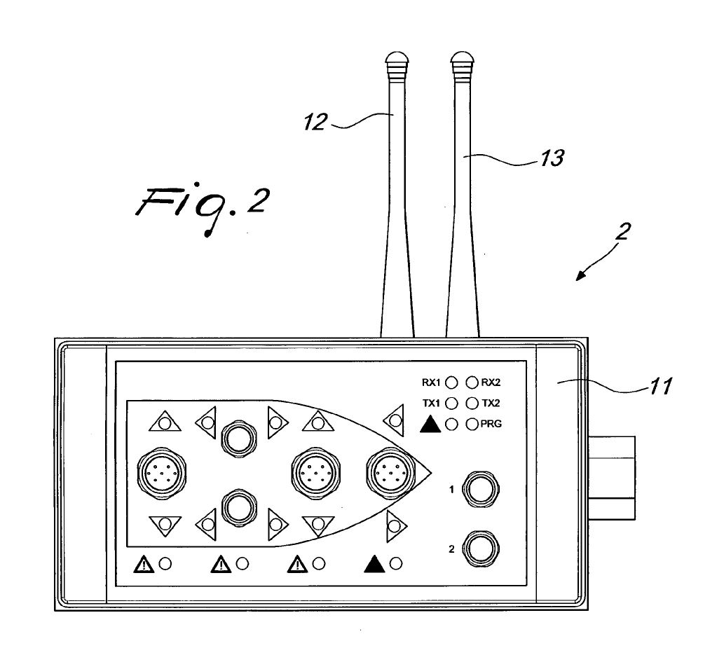

FIG. 2 is a schematic view of the receiver of the control device according to the present invention;

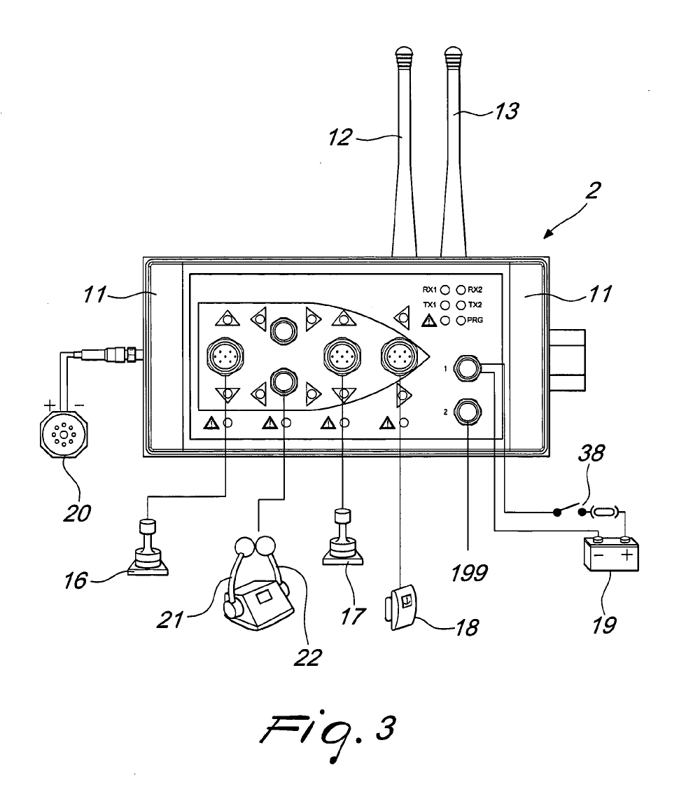

FIG. 3 is a schematic view of the connection of the outputs of the receiver to various control devices provided on the boat and of connections to a battery and to an acoustic transducer, according to the present invention;

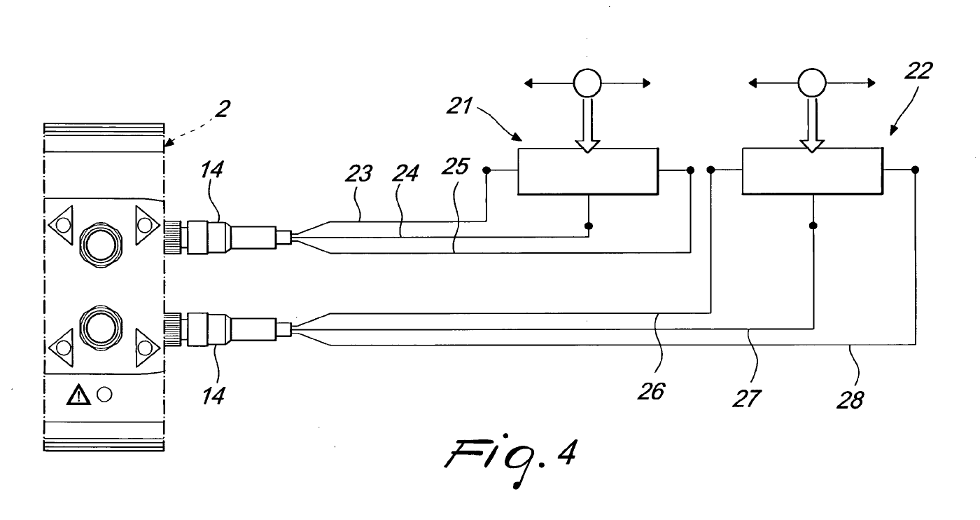

FIG. 4 is a schematic view of the connection of the receiver used in the present invention to the control levers of the boat;

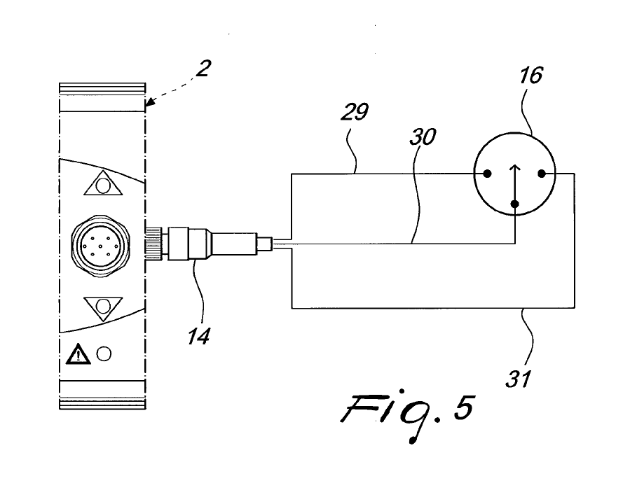

FIG. 5 is a schematic view of the connections of the receiver used in the present invention to the stem thruster of the boat;

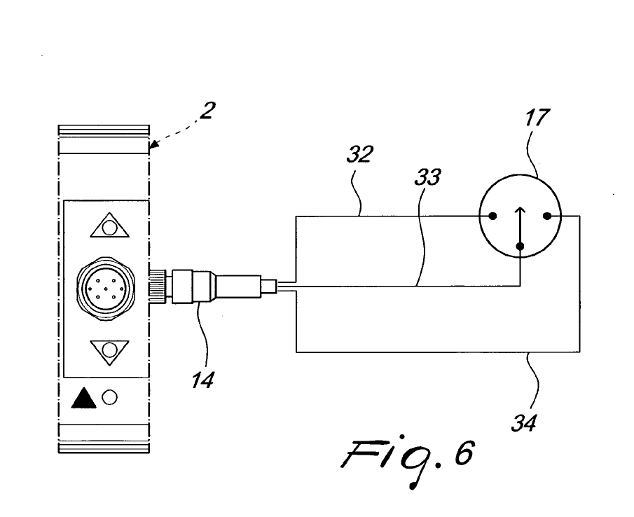

FIG. 6 is a schematic view of the connection of the receiver used in the present invention to the stern thruster of the boat;

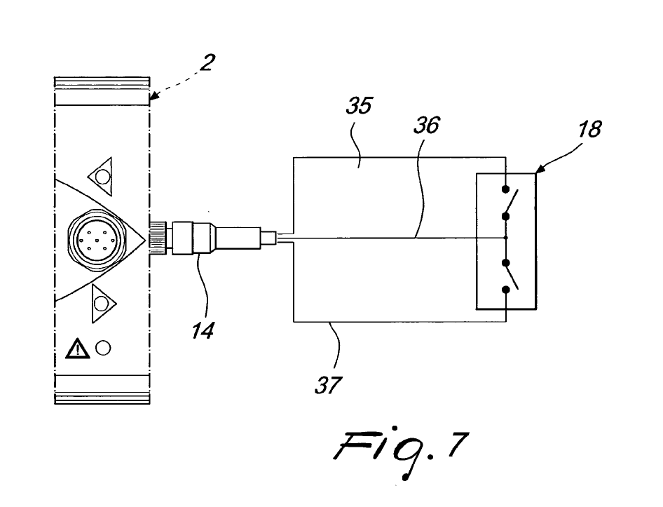

FIG. 7 is a schematic view of the connection of the receiver used in the present invention to the anchor winch of the boat;

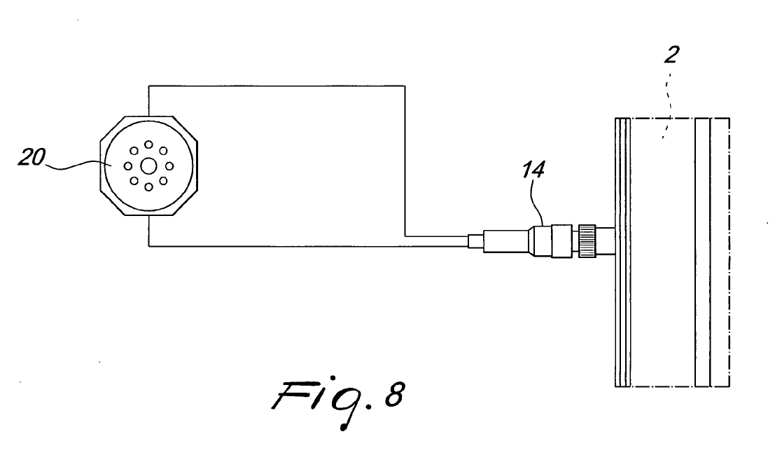

FIG. 8 is a schematic view of the connection of the receiver used in the present invention to an external device for generating an acoustic signal; and

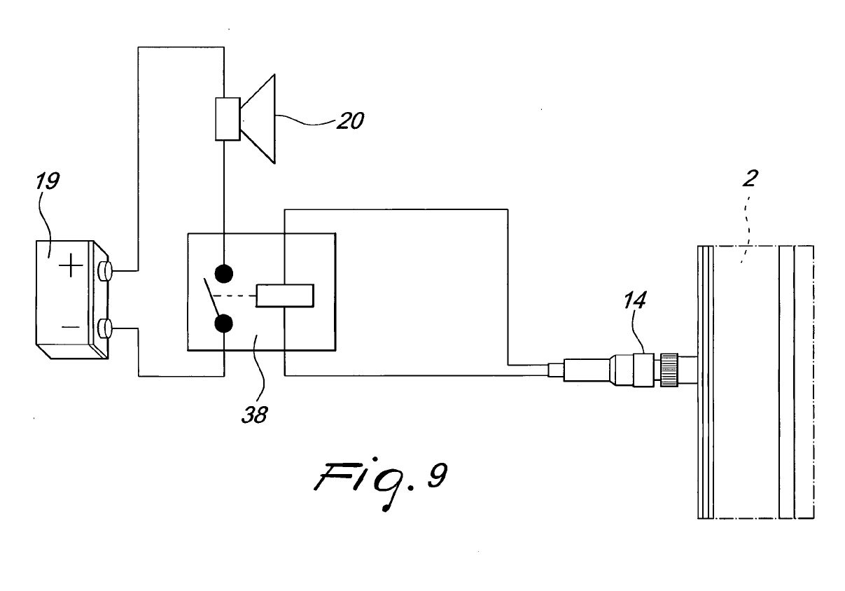

FIG. 9 is a schematic view of an alternative arrangement for connecting the receiver to an acoustic transducer, in which the transducer is controlled by an external relay.

With reference to the cited figures, the controller according to the invention comprises two main components: a wireless transmitter, designated by the reference numeral 1, to be held in one's hand, and a receiver 2, which is mounted at or near the conventional controls of the yacht or other boat.

The term “yacht” or “boat” in the present patent application includes a vessel in general.

The receiver 2 is suitable to receive signals from the transmitter 1 and to generate commands in response to the signal; the commands control the operation of the yacht. The outputs of the receiver 2 are substantially connected in parallel to the existing controls of the yacht. The wireless transmitter 1 does not replace the existing controls.

The controller according to the invention therefore allows to control the yacht manually in a conventional manner, i.e., by operating the levers that actuate controls and also by remote control by using the handheld unit 1.

The transmitter 1 has one or more microprocessors, which are arranged within the receptacle of the transmitter and are not visible in the figures.

The microprocessors are programmed to emit a plurality of distinct signals on two different frequency bands. The signals can be recognized by the receiver 2, which is provided with two receiver modules tuned to each of the two bands.

The range of the transmitter is intentionally limited in order to minimize interference with other electronic devices in the vicinity.

Also, in the preferred embodiment, the signal of the transmitter includes a digital code, which is unique for the owner of the unit.

The digital code can be pre-programmed at the factory.

The transmitter 1, which is handheld by the operator, includes a plurality of actuation systems constituted by levers, switches and buttons for controlling the various functions of the yacht.

The number of actuation systems can vary depending on which devices are installed on the yacht and how much one wishes to control.

In the example shown in FIG. 1, the yacht has two engines, a left one and a right one, bow and stern thrusters, and an anchor winch.

The illustrated device has an actuation system, designated by the reference numerals 3 and 4, for each engine and a single actuation system, designated by the reference numerals 5 and 6 and movable to the left or to the right, for each one of the stem and stern thrusters.

The device also includes an actuation system 7 for controlling the anchor which.

The electronic components of the transmitter are preferably accommodated in a container made of ABS plastic, which is water-resistant.

The container includes preferably two half-shells, which mutually interlock.

The transmitter is battery-powered and the batteries can be replaced by accessing the hermetic battery compartment located on the back of the container.

It is of course possible to use other power sources to supply power to the transmitter, such as for example solar energy.

The transmitter 1 also includes three light-emitting diodes (LED's): two LED's, designated by the reference numerals 8 and 9, one for each transmission band, light up when the control signals are transmitted from the handheld unit to the receiver on each band and confirm command transmission.

The third LED 10 lights up when the energy available from the batteries drops below a preset level and is a signal for the user to replace the batteries.

The receiver 2 is accommodated in a plastic container body 11 and is preferably mounted by using screws, which engage holes arranged at the corners of the body of the receiver.

The receiver is provided with two antennas 12 and 13, one for each communication frequency band, as shown in FIG. 2.

The device according to the present invention is designed for use with yachts or boats in general which have electronic, electromechanical or mechanical controls which include control levers or buttons or equivalents thereof, which actuate relays or switches which send a control signal to a desired component, such as for example an engine.

The device according to the present invention works by generating commands that have the same effect on the components of the boat as the commands produced by the conventional control systems that are already present on the boat. Indeed, the commands produced by the transmitter 1 are indistinguishable, for the systems of the boat, from the commands produced by the conventional systems.

An important characteristic of the invention is that the outputs of the receiver 2 are connected to actuate the conventional controls of the boat without disturbing the functionality of these conventional controls. Therefore, the outputs of the receiver 2 are connected in parallel to the existing controls of the boat.

It is important to note that the device according to the present invention can be used on existing boast without the need to modify the circuits that exist on the boat.

FIG. 3 shows an example of connection of the outputs of the receiver 2 to the controls of the boat. The function of each connector is identified in FIG. 3.

The main control components of the boat are shown at the bottom of FIG. 3: the control levers 21 and 22 of the engines, the joystick or switches 16 and 17 of the stern and bow thrusters respectively, and the control switch 18 of the anchor winch.

FIG. 3 also illustrates the connection to a battery 19 which supplies power to the receiver 2 and an acoustic transducer 20 which produces an alarm sound when the radio link between the transmitter and the receiver is interrupted for any reason.

FIG. 9 shows in greater detail the connection to the battery, which is effected through an on/off fused switch 38.

FIG. 9 also shows the acoustic transducer 20 connected to the switch 38.

A further power supply connector 199 is provided for supplying an interface or any other device.

All the connections are provided through hermetic output connectors 14, shown in FIGS. 4 to 9.

FIG. 4 shows in greater detail an example of the connection of the outputs of the receiver 2 to the controls of the left and right engines, designated respectively by the reference numerals 21 and 22.

The connections include a forward right engine connection 23, a common right engine connection 24 and a reverse right engine connection 25, a forward left engine connection 26, a common left engine connection 27 and a reverse left engine connection

As stated earlier, these outputs are connected in parallel to the outputs of the conventional controls.

FIG. 5 shows in greater detail an example of the connection of the outputs of the receiver 2 to the joystick 16, or equivalent switches, for controlling the stem thruster.

The connections include a left stem thruster connection 29, a common stem thruster connection 30 and a right stem thruster connection 31.

FIG. 6 shows in greater detail an example of the connection of the outputs of the receiver 2 to the joystick 17 or equivalent switches for controlling the stern thruster.

The connections include a left stern thruster connection 32, a common stern thruster connection 33 and a right stern thruster connection 34.

FIG. 7 shows in greater detail an example of the connection of the outputs of the receiver 2 to the switches 18 that control the anchor winch.

The connections include a raised anchor position connection 35, a common position connection 36 and a lowered anchor position connection 37.

It should be noted that in each case the outputs 14 of the receiver 2 are not connected directly to the engines, thrusters or winch but rather are connected to the levers, joystick or other anchor winch control switch.

FIG. 8 shows in greater detail the connection of the receiver 2 to the transducer 20 or other device that provides the acoustic signal.

If the acoustic signal requires a current of more than 30 mA, the signal from the receiver 2 is preferably connected across a relay, as shown in FIG. 9.

The connection of the outputs of the receiver 12 in parallel to the existing control lines constitutes a safety characteristic and a technical advantage of the present invention.

It is a safety characteristic because the arrangement allows the levers of the conventional controls to operate normally, so that the operator can immediately resumes conventional control of the boat if necessary.

It is a technical advantage because it allows the system to be installed on existing boats without modifying the controls of the boat.

The receiver 2 can be activated by a separate switch, which is preferably installed near the control post of the yacht.

The receiver 2 receives the commands generated by the transmitter 1 on the two frequency bands and activates the functions of the boat depending on the received command.

It is possible to provide a receiver 2 that can receive signals from more than one transmitter 1, provided that the transmitters do not operate simultaneously.

In case of interruption or malfunction of the communication between the transmitter 1 and the receiver 2, on both frequency bands, the receiver automatically places the engines in a “neutral” condition and activates an acoustic signal to warn the operator that communication with the transmitter has been lost.

When it is on, the transmitter 1 begins to communicate with the receiver 2, although in order to increase the reliability and safety of the system it is not yet capable of controlling it effectively.

For this purpose it is necessary to perform on the transmitter an engagement procedure, which consists in pressing twice in sequence the “*” (asterisk) button that is present on the transmitter 1.

At this point it is possible to send commands to the receiver 2.

These commands are sent continuously to the receiver and are representative of the status of the respective actuation systems on the transmitter.

A command remains “active” as long as its corresponding actuation system is activated.

In a preferred embodiment, the transmitter 1 generates signals cyclically, i.e. generates sequential signals that represent the status of each actuation system, repeating this sequence of signals continuously.

The transmitter preferably includes, outside its receptacle, a graphical representation 40 of a boat, as shown in FIG. 1.

This graphical representation 40 assists the user in activating the actuation systems.

The actuation systems on the diagram of the transmitter are arranged in such a position as to correspond to the functions of each actuation system. For example, the actuation systems 3 and 4 that control the right and left engines are located at the right and left sides, respectively, of the diagram 40. The actuation systems 5 and 6 for the stem and stern thrusters are located respectively at the stem and stern of the boat represented by the diagram. The actuation systems 7 for the anchor winch are arranged in the front part of the diagram of the boat.

The arrangement given above is of course preferred, but the system might be designed so that the controls of the transmitter are arranged in some other configuration and not necessarily in the configuration of a boat.

The operation of the device according to the present invention is as follows.

First of all, the main engines of the boat are started in the usual manner.

Then the control post to which the receiver 2 of the present invention is connected is switched on.

During use of the device according to the invention, the control levers of the boat must remain in the “neutral” position, in order to avoid a conflict between the commands generated by the movement of the levers and the commands generated by the transmitter 1.

The receiver 2 is switched on by using a fixed switch that is installed at or near the receiver. In approximately two seconds, the receiver starts to emit its acoustic signal, indicating that the receiver is on but has not established radio contact with the transmitter.

The transmitter 1 is then switched on, using the power-on button 41. The device is preferably programmed in such a manner that the button 41 is kept pressed for approximately 3 seconds in order to be sure that it has been pressed intentionally.

The transmitter then begins its periodic and repetitive transmission of signals to the receiver but is not yet capable of sending commands. This condition is indicated on the transmitter 1 by the fixed lighting of the two transmission LED's 8 and 9 and on the receiver 2 by the interruption of the acoustic signal indicating lack of communication.

At this point, in order to be able to proceed with the sending of the commands to the receiver it is necessary to perform on the transmitter the engagement procedure by pressing twice sequentially the asterisk button 39 on the transmitter.

When the transmitter sends commands, the LED's 8 and 9 that indicate transmission on the two frequency bands light up alternately. It is at this point possible to control the engines, the thrusters, the anchors, et cetera simply by activating the corresponding actuation systems on the handheld transmitter.

In order to increase the endurance of the batteries, preferably the transmitter is programmed to switch itself off after a preset time interval, for example four minutes, has elapsed after the last activation of any actuation system on the unit. The transmitter is deactivated by pressing the on-off button 41 for a time that is longer than a preset period, for example three seconds, so as to prevent accidental power-off of the unit.

When the unit is switched off, the transmission LED's 8 and 9 are deactivated and the receiver 2 produces its acoustic alarm signal caused by the interruption of communication between the transmitter and the receiver.

The receiver is then deactivated by using its on/off switch.

It should be noted that in case of emergency it is possible to deactivate the system simply by switching off the on/off switch associated with the receiver without switching off the transmitter.

If the receiver is switched off, the commands from the transmitter cannot be received and executed.

The device according to the present invention allows an operator essentially complete control from any location on the boat.

In particular, it is possible to control any one of the various engines, thrusters or anchor winches, provided that the boat includes circuits for controlling these components electronically, electromechanically or mechanically.

Since the transmitter 1 small, it can be handheld by the user or fixed to the wrist or hung from the neck. By hanging the device from the neck, for example, the operator can use his hands to throw ropes and help in mooring.

The paragraphs that follow describe the operation of the system in various typical uses.

1. Untying the Boat.

The system is activated as described above. With the control levers in the neutral position, the user begins to disengage from the mooring by going to the stern of the boat and releasing the ropes that hold the boat to the wharf. Then one goes to the stem and raises the anchor by using the control on the handheld transmitter. In this manner it is possible to use the complete visibility that is allowed by staying at the stern or in another point that is close to the anchor and it is possible to correct the movement of the boat with the aid of the engines or of the stem and stern thrusters to compensate for the effects of wind or of wave motion. At this point it is possible to retrieve the fenders and it is possible to switch off the system by using the deactivation procedure described above. Conventional control of the boat is then resumed.

2. Tying the Stern to the Mooring

Once inside the port, and with the control levers in the neutral position, the system is activated as described above. After positioning the fenders and arriving proximate to the space assigned to the boat, one goes to the stern and begins the entry maneuver with complete visibility of the wharf. During this maneuver it is possible to use the transmitter to perform immediate corrections of the position of the boat, as required by the effects of the wind and of wave motion. One then goes to the stem and lowers the anchor, using the transmitter and paying attention to make the boat advance with a brief forward command to the engine in order to avoid striking the wharf with the stern. At this point it is possible to move the stern and send a brief command to reverse the engines in order to tie the stern to the wharf with the assistance of the personnel on the wharf or with the assistance of a crewmember. Even in cases in which the boat does not have an electric winch, the process of raising or lowering the anchor can be simplified enormously by using short commands to the engine, producing the forward or backward motion of the boat, so as to control the tension in the ropes. The system can then be deactivated as described above.

3. Lowering the Anchor

After choosing the desired position for mooring, the control levers are placed in the neutral position and the system is activated as described above. One goes to the stem and, after checking the depth of water and any presence of other anchors or chains, the descent of the anchor is controlled by using the anchor control on the transmitter. After lowering the anchor to the correct depth, and after providing the necessary quantity of rope or chain, the transmitter is activated to reverse the engines in order to check the grip on the seabed and the direction of the chain of the anchor. When the maneuver has been completed, the system is deactivated as described above.

4. Lifting the Anchor

The control levers are placed in the neutral position and the system is activated as described above; one goes to the stem to check that the cable or chain is rising freely and short pulses are given to the anchor winch in order to avoid excessive tension on the winch. Once the anchor has been raised, the system is deactivated as described above.

5. Docking to a Mooring Buoy

The control levers are placed in the neutral position and the system is activated as described above. Differently from the conventional procedure, in which a person must stay close to the stem with a boathook or a hook in order to engage the mooring buoy, the boat is maneuvered with the transmitter and one is able to pick up the buoy at the stem. From this position it is simple to tie the buoy and drag the rope to the stem in order to fix it to the front cleat. After completion of this procedure, system can be deactivated as described above.

6. Release from a Mooring Buoy

The control levers are placed in the neutral position and the system is activated as described above. One then goes to the stem and releases the rope from the cleat and makes it slide away from the buoy. The transmitter is operated to provide short pulses to the engines in order to contrast the drift of the boat caused by the wind and thus avoid collisions with other boats. The system can then be deactivated as described above.

In addition to the situations described above, the device according to the invention can be useful in many others. For example, when the boat is tied to a mooring, for supply or for loading provisions, particularly in limited spaces, it is easy to control the boat by placing oneself in the points of maximum visibility, using the handheld transmitter without risking collisions and without having to shout to crew members for help.

When the boat is in shallow water or near submerged rocks or other obstacles, the operator can control the boat accurately either from the stem or from the sides or from the stern, so as to avoid damaging the propellers, shafts or other submerged components and reduce the risk of running aground.

Even when mooring or when approaching another boat, the operator can control the boat from the sides or from the stern or from the stem. The user can place himself in the best position for estimating the distance to the dock or other boat, thus improving the accuracy of the maneuver.

In a further example, the controller according to the present invention is useful is if it is necessary to pick up a buoy without assistance: the device allows to maneuver the boat precisely to the side of the buoy.

In practice it has been found that the invention achieves the intended aim and objects, providing a device that allows to control the essential functions of a boat from any position on the boat. The operator can position himself so to have the best possible view of the dock or anchor, yet he can control the boat as if he were at the maneuvering post.

The number of switches on the transmitter can be changed according to the number of controllable components provided on the boat. Therefore, for single-engine boats the handheld transmitter may have a single switch or lever. For boats with two engines but without thrusters the control device might have only switches for controlling the engines and the switches for the thrusters might be omitted.

The receiver can be installed in various positions on the boat, although preferably not in places subject to flooding or high temperatures in order to avoid damage thereto.

An important factor to be considered in positioning the receiver is the possibility of the operator to hear the acoustic signal from the receiver. However, it is possible to install an acoustic generator in a different position than the receiver.

The materials used, as well as the dimensions, may of course be any according to the requirements and the state of the art.

This application claims the priority of Italian Patent Application No. MI2009A000176, filed on Feb. 11, 2009, the subject matter of which is incorporated herein by reference.

1. A remote controller for a boat comprising at least one electronic, electromechanical or mechanical control and at least one manual control connected to said electronic, electromechanical or mechanical control for its actuation, said controller comprising a handheld mobile transmitter and a receiver located on the boat, said transmitter being capable of generating signals that can be detected by the receiver without a wired connection between the transmitter and the receiver; said receiver having at least one output connected functionally to said at least one electronic, electromechanical or mechanical control of the boat in parallel with an output of said manual control; said transmitter not replacing the existing controls of the boat; said controller being characterized in that said transmitter is capable of generating signals on at least two different frequency bands which can be detected by the receiver without a wired connection between the transmitter and the receiver.

2. The controller according to claim 1, characterized in that said receiver is provided with at least two different receiver stages; one receiver stage for each of the frequency bands emitted by the transmitter.

3. The controller according to claim 2, characterized in that each receiver stage is autonomous and receives the same information, allowing to maintain control even in the presence of interference or malfunctions on one of the two transmitted bands.

4. The controller according to claim 1, characterized in that said receiver comprises a means for activating an alarm when the wireless communication between the transmitter and the receiver is interrupted.

5. The controller according to claim 1, characterized in that said transmitter comprises a containment body which has a graphical representation of the boat and in that each actuation system is arranged on said graphical representation at a component of the boat to be controlled.

6. The controller according to claim 1, characterized in that said transmitter comprises actuation systems that control all the available engines of the boat.

7. The controller according to claim 1, characterized in that said boat has a plurality of engines and a plurality of electronic, electromechanical or mechanical controls, and wherein all the engines of the boat are controlled by respective controls.

8. A method for modifying a boat so as to allow remote control of the boat, the boat having a manual control which has an output which is connected to actuate an electronic, electromechanical or mechanical control; characterized in that it connects an output of a receiver to a same control which can be actuated by means of said manual control, the receiver being suitable to receive on at least two different frequency bands wireless signals from a handheld transmitter, wherein the connection step is performed without disturbing a connection between the manual control and the electronic, electromechanical or mechanical control, wherein a signal generated by the receiver acts in parallel with a signal from said manual control.

9. The method according to claim 8, characterized in that said boat is chosen to have a plurality of engines and a plurality of electronic, electromechanical or mechanical controls; said method furthermore comprising connecting the receiver to each one of said controls, so that said plurality of engines can be controlled by a signal from the receiver.
